(19) United States
(12) Patent Application Publication
(10) Pub. No.: US 2024/0014436 A1
(43) Pub. Date: Jan. 11, 2024

(54) LITHIUM-ION BATTERY MANUFACTURING DEVICE AND MANUFACTURING METHOD

(71) Applicant: APB CORPORATION, Fukui (JP)

(72) Inventors: Hideaki HORIE, Fukui (JP); Yusuke NAKASHIMA, Kyoto (JP); Mayu NAITOU, Kyoto (JP); Shinya KOBAYASHI, Kyoto (JP); Ryosuke KUSANO, Kyoto (JP)

(21) Appl. No.: 18/035,447

(22) PCT Filed: Nov. 5, 2021
(86) PCT No.: PCT/JP2021/040740

§ 371 Date: May 4, 2023

(30) Foreign Application Priority Data
Nov. 6, 2020 (JP) 2020-185669

(51) Int. Cl. H01M 10/04; H01M 10/0525; H01M 10/0585

(52) U.S. Cl. CPC H01M 10/0486; H01M 10/0404; H01M 10/0525; H01M 10/0585

(57) ABSTRACT

A lithium-ion battery manufacturing device and a lithium-ion battery manufacturing method can suppress variation in thickness and shape distortion of a lithium-ion battery. The lithium-ion battery includes a cathode current collector, a cathode active material layer, a separator, an anode active material layer, and an anode current collector that are stacked. The lithium-ion battery has a circular frame member that fixes an outer edge of the separator, which is placed between the cathode current collector and the anode current collector, and that seals the cathode active material layer, the separator, and the anode active material layer. The lithium-ion battery manufacturing device includes: a holder that sandwiches the lithium-ion battery from both sides of the stacking direction; and a sealing device that has a frame-shaped heater, which heat-seals an outer edge of the lithium-ion battery by heating the frame member placed at the outer edge.

### FIELD OF THE INVENTION

This invention relates to a lithium-ion battery manufacturing device and a lithium-ion battery manufacturing method.

### BACKGROUND ART

Conventionally, a lithium-ion battery is widely used in portable devices such as smartphones, hybrid cars, electric cars, and so on. Recently, a lithium-ion battery has also received more attention as a large-capacity battery for stationary power supply at offices and power stations. As such, a large-capacity lithium-ion battery, lithium-ion battery, which has a sheet-shaped or plate-shaped rectangular in plain view, and which has a cathode current collector on one side and an anode current collector on the other side, is known. The outer edges of a lithium-ion battery are heat-sealed one by one by a sealing device (refer to Patent Reference 1).

### CITATION LIST

### Patent Literature

[Patent Reference 1] Japanese Unexamined Patent Application Publication No. 2019-212384

### BRIEF SUMMARY OF THE INVENTION

### Problems that Invention is to Solve

However, by sequentially heat-sealing each side, the end parts (corner) of the previously heat-sealed side are heat-sealed repeatedly. When four sides have been heat-sealed, the corners of the lithium-ion battery, which is rectangular in plain view, have been heat-sealed repeatedly. The double heat-sealed parts and their peripheral parts are likely to have a thermal deformation, causing variations in thickness and deformation of the shape. In order to solve the problems caused by such overlapped heat sealing, a method of heat sealing while pressing not only the outer edge part but also the entire surface of a lithium-ion battery is also conceivable. However, with this method, pressing the entire surface may adversely affect the electrode portion. Therefore, it is necessary to solve the above-described problem with another method.

The present invention has been made in view of the above-mentioned problems and has an objective to provide a lithium-ion battery manufacturing device and a lithium-ion battery manufacturing method, which can suppress variation in thickness and shape distortion of a lithium-ion battery.

### Means to Solve the Problems

A lithium-ion battery manufacturing device according to one variation of this invention, wherein the lithium-ion battery comprises a cathode current collector, a cathode active material layer, a separator, an anode active material layer, and an anode current collector that are stacked, wherein the lithium-ion battery has a circular frame member that fixes an outer edge of the separator, which is placed between the cathode current collector and the anode current collector, and that seals the cathode active material layer, the separator, and the anode active material layer, and wherein the lithium-ion battery manufacturing device comprising: a holder that sandwiches the lithium-ion battery from both sides of the stacking direction; and a sealing device that has a frame-shaped heater, which heat-seals an outer edge of the lithium-ion battery by heating the frame member placed at said outer edge of the lithium-ion battery.

Since this lithium-ion battery manufacturing device comprises the frame-shaped heater, the heater can be in contact with four sides of the outer edge of the lithium-ion battery and can heat-seal simultaneously said four sides. Therefore, the four sides of the lithium-ion battery are uniformly heat-sealed. This can prevent the corners only from being heat-sealed more times than the rest of the outer edge. Further, this manufacturing device comprises the holder that sandwiches and holds the lithium-ion battery from both sides along the stacking direction. Therefore, it is also possible to suppress variations in thickness and shape deformation of the lithium-ion battery in the heat-sealing step.

In this invention, preferably, wherein the frame member holds the separator by sandwiching the outer edge of the separator from both sides along the stacking direction and surrounds outer peripheries of the cathode active material layer and the anode active material layer, wherein the separator separates the cathode active material layer and the anode active material layer, wherein the lithium-ion battery is formed as a rectangular plate that has the cathode current collector whose outer edge is fixed to one side of the frame member so as to cover the cathode active material layer, and the anode current collector whose outer edge is fixed to another side of the frame member so as to cover the anode active material layer, and wherein the heater is pressed on the outer edge of the lithium-ion battery and heats the frame member.

In this invention, preferably, the holder is configured to hold the lithium-ion battery while being in contact with an entire inner surface of the outer edge of the lithium-ion battery. With this configuration, this invention can increase the effect of suppressing variation in thickness and shape distortion of a lithium-ion battery.

Preferably, the lithium-ion battery manufacturing device further comprises a radiator that is in contact with four sides of the outer edge of the lithium-ion battery, and that is operable to simultaneously promote heat dissipation from said four sides. The distortion of lithium-ion batteries can also be caused by heat dissipation after the heat-sealing step. The lithium-ion battery manufacturing device comprises a radiator that is in contact with four sides of the outer edge of the lithium-ion battery, and that is operable to simultaneously promote heat dissipation from said four sides of the lithium-ion battery. As a result, since the heat dissipation of the four sides of the outer edge is conducted uniformly, variations in thickness and shape distortion of the lithium-ion battery due to heat dissipation are also suppressed.

In this invention, preferably, the radiator is a rectangular frame-shaped member and is divided into two U-shaped members. Since the radiator is divided into two U-shaped members, with the holders sandwiching the lithium-ion battery from both sides of the stacking direction, it is possible to easily bring the radiator into contact with the lithium-ion battery while avoiding interference with the holder.

Preferably, the lithium-ion battery manufacturing device further comprises a conveying device that is operable to convey the lithium-ion battery and the radiator, while the radiator is in contact with the four sides of the outer edge of the lithium-ion battery.

The conveying device is operable to convey the lithium-ion battery and the radiator while the radiator is in contact with the four sides of the outer edge of the lithium-ion battery. With this, the outer edges of the lithium-ion battery are evenly dissipated after the conveying, and variations in the thickness and shape distortion of the lithium-ion battery are suppressed even after the lithium-ion battery is carried out. Furthermore, variations in the thickness of the outer edge and shape distortion are mechanically suppressed by the radiator.

A lithium-ion battery manufacturing method according to one variation of this invention, wherein the lithium-ion battery comprises a cathode current collector, a cathode active material layer, a separator, an anode active material layer, and an anode current collector that are stacked, wherein the lithium-ion battery has a circular frame member that fixes an outer edge of the separator, which is placed between the cathode current collector and the anode current collector, and that seals the cathode active material layer, the separator, and the anode active material layer, and wherein the lithium-ion battery manufacturing method comprising: a holding step of sandwiching the lithium-ion battery from both sides of the stacking direction using a holder; and a heat-sealing step of heat-sealing an outer edge of the lithium-ion battery by heating the frame member placed at said outer edge of the lithium-ion battery using a frame-shaped heater of a sealing device.

In this method, preferably, wherein the frame member holds the separator by sandwiching the outer edge of the separator from both sides along the stacking direction and surrounds outer peripheries of the cathode active material layer and the anode active material layer, wherein the separator separates the cathode active material layer and the anode active material layer, wherein the lithium-ion battery is formed as a rectangular plate that has the cathode current collector whose outer edge is fixed to one side of the frame member so as to cover the cathode active material layer, and the anode current collector whose outer edge is fixed to another side of the frame member so as to cover the anode active material layer, and wherein the heater is pressed on the outer edge of the lithium-ion battery and heats the frame member in the heat-sealing step.

In this method, preferably, the holder holds the lithium-ion battery while being in contact with an entire inner surface of the outer edge of the lithium-ion battery in the holding step.

Preferably, the manufacturing method further comprises a heat dissipation step of simultaneously promoting heat dissipation from four sides of the outer edge of the lithium-ion battery while a radiator is in contact with said four sides.

In this method, preferably, the radiator is a rectangular frame-shaped member and is divided into two U-shaped members.

Preferably, the manufacturing method further comprises a conveying step of conveying the lithium-ion battery and the radiator using a conveying device, while the radiator is in contact with the four sides of the outer edge of the lithium-ion battery.

### Effects of the Invention

A lithium-ion battery manufacturing device and a lithium-ion battery manufacturing method, which can suppress variation in thickness and shape distortion of a lithium-ion battery, can be provided by the present invention.

### BRIEF DESCRIPTION OF DRAWINGS

FIG. 1 is a cross-sectional view schematically showing a constitution of a lithium-ion battery manufacturing device according to a first embodiment of this invention.

FIG. 2 is a cross-sectional view schematically showing an enlarged outer edge of a lithium-ion battery that is heat-sealed by said manufacturing device.

FIG. 3 is a bottom view along III-III in FIG. 1, schematically showing a holder and a sealing device of the manufacturing device.

FIG. 4 is a perspective view schematically showing a constitution of the sealing device.

FIG. 5 is a cross-sectional view schematically showing a constitution of a holder and a radiator of the manufacturing device.

FIG. 6 is a bottom view along VI-VI in FIG. 5, schematically showing the holder and the sealing device.

FIG. 7 is a perspective view schematically showing a constitution of the holder and the radiator.

FIG. 8 is a cross-sectional view schematically showing a constitution of a lithium-ion battery module having a plurality of stacked lithium-ion batteries.

FIG. 9 is a flowchart showing a lithium-ion battery manufacturing method by the manufacturing device.

FIG. 10 is a perspective view schematically showing a heat-sealing step.

FIG. 11 is a cross-sectional view schematically showing an enlarged outer edge of a lithium-ion battery that is heat-sealed in the heat-sealing step.

FIG. 12 is a cross-sectional view schematically showing a heat dissipation step.

FIG. 13 is a cross-sectional view schematically showing a conveying step.

FIG. 14 is a perspective view schematically showing a sealing device according to a second embodiment of this invention.

FIG. 15 is a perspective view schematically showing a sealing device according to a third embodiment of this invention.

FIG. 16 is a perspective view schematically showing a sealing device according to a fourth embodiment of this invention.

FIG. 17 is a cross-sectional view schematically showing another enlarged outer edge of a lithium-ion battery that is heat-sealed by the manufacturing devices according to the first to fourth embodiments.

FIG. 18 is a plane view schematically showing measured parts of a thickness of a lithium-ion battery after the heat-sealing according to the embodiments and comparisons.

### DESCRIPTION OF EMBODIMENTS

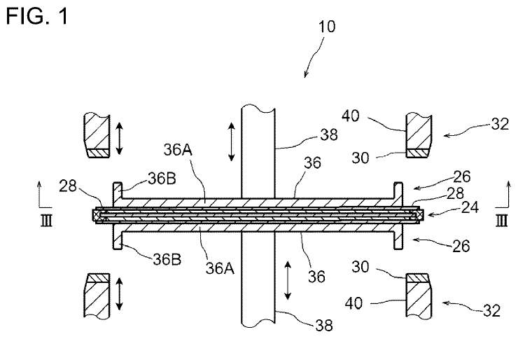

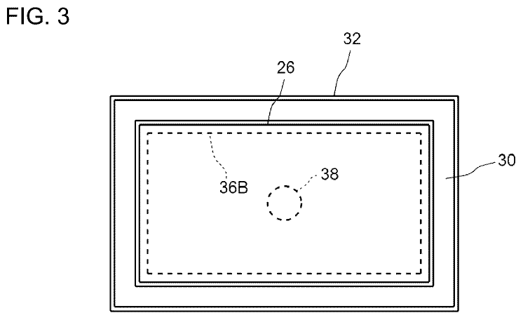

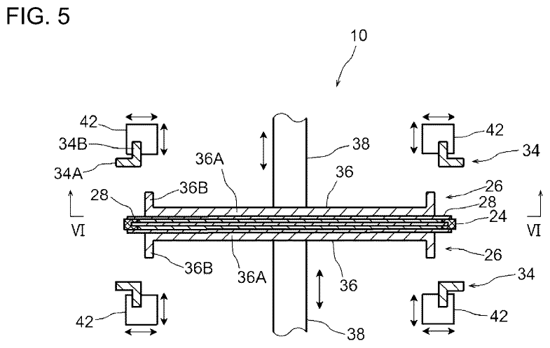

As shown in FIG. 1 to FIG. 4, a lithium-ion battery manufacturing device 10 according to the first embodiment, wherein the lithium-ion battery 24 comprises a cathode current collector 12, a cathode active material layer 14, a separator 16, an anode active material layer 18, and an anode current collector 20 that are stacked, wherein the lithium-ion battery 24 has a circular frame member 22 that fixes an outer edge of the separator 16, which is placed between the cathode current collector 12 and the anode current collector 20, and that seals the cathode active material layer 14, the separator 16, and the anode active material layer 20, and wherein the manufacturing device 1 for a lithium-ion battery comprising: a holder 26 that sandwiches the lithium-ion battery 24 from both sides of the stacking direction; and a sealing device 32 that has a frame-shaped heater 30, which heat-seals an outer edge 28 of the lithium-ion battery 24 by heating the frame member 22 placed at said outer edge 28 of the lithium-ion battery 24. Furthermore, as shown in FIG. 5 to FIG. 7, the lithium-ion battery manufacturing device 10 comprises a radiator 34 that is in contact with four sides of the outer edge 28 of the lithium-ion battery 24, and that is operable to simultaneously promote heat dissipation from said four sides of the lithium-ion battery 24.

The holder 26 is configured to hold the lithium-ion battery 24 while being in contact with an entire inner surface of the outer edge 28 of the lithium-ion battery 24. Specifically, the holder 26 has a holding part 36 and a support part 38. The holding part 36 comprises a rectangular plate-shaped contact part 36A having substantially the same shape as the entire inner surface of the outer edge 28 of the lithium-ion battery 24, and an outer wall part 36B projecting from the outer edge of the contact part 36A to the side, which is opposite to the side that is in contact with the lithium-ion battery 24. The support part 38 is a bar-shaped member that protrudes from the central portion of the contact part 36A toward the side opposite to the side that is in contact with the lithium-ion battery 24. A pair of holders 26 are provided in the lithium-ion battery manufacturing device 10. Since the pair of holders 26 are configured to approach/separate from each other along the vertical direction by a drive mechanism (not shown in the figure) connected to the support part 38, the lithium-ion battery 24 can be held/released.

The sealing device 32 comprises a square frame-shaped base member 40 and a square frame-shaped heater 30, which is attached to the side of the base member 40 facing the lithium-ion battery 24. The sealing device 32 is shaped to fit loosely on the outside of the outer wall part 36B of the holder 26. A pair of sealing devices 32 are equipped with the lithium-ion battery manufacturing device 10. The pair of sealing devices 32 are configured to approach/separate from each other along the vertical direction by a drive mechanism (not shown in the figure) connected to the base member 40. By approaching the pair of sealing devices 32 closer to each other, the heater 30 can sandwich and press the outer edge 28 of the lithium-ion battery 24 and heat the frame member 22. The heater 30 is in contact with four sides of the outer edge 28 of the lithium-ion battery 24 and can heat-seal simultaneously said four sides. The heater 30 has a heating element such as a heating wire inside.

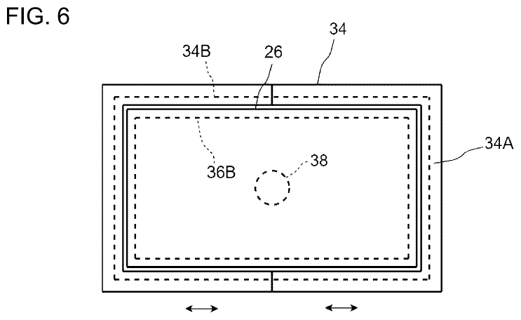

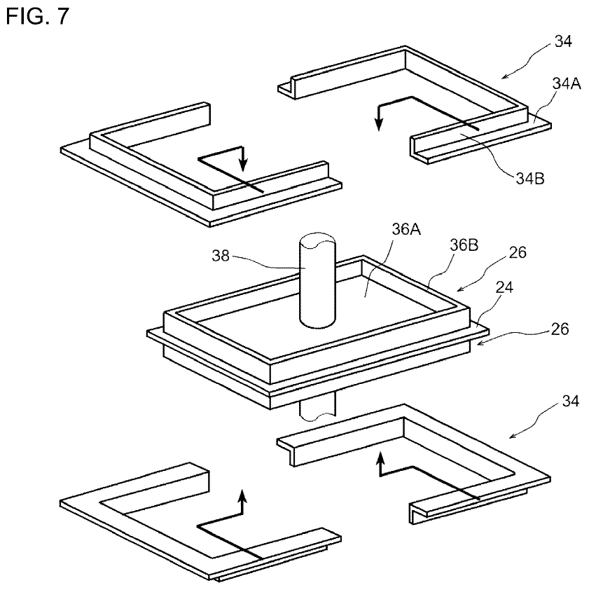

The radiator 34 is a rectangular frame-shaped member and comprises a contact part 34A having substantially the same shape as the outer edge 28 of the lithium-ion battery 24, and an inner wall part 34B projecting from the inner edge of the contact part 34A to the side, which is opposite to the side that is in contact with the lithium-ion battery 24. The inner wall part 34B of the radiator 34 is shaped to fit loosely on the outside of the outer wall part 36B of the holder 26. A pair of radiators 34 are equipped with the lithium-ion battery manufacturing device 10. The pair of radiators 34 are held by a conveying device 42 and configured to approach/separate from each other along the vertical direction. The pair of radiators 34 approach each other along the vertical direction so that they sandwich both sides of the outer edge 28 of the lithium-ion battery 24. As a result, the pair of radiators 34 can be in contact with both sides of the outer edge 28. As shown in FIG. 6 and FIG. 7, each radiator 34 is divided into two U-shaped members. The two U-shaped members constituting each radiator 34 are held by the conveying device 42 so as to approach/separate from each other along the horizontal direction. The two U-shaped members approach each other along the horizontal direction to form the rectangular frame-shaped radiator 34.

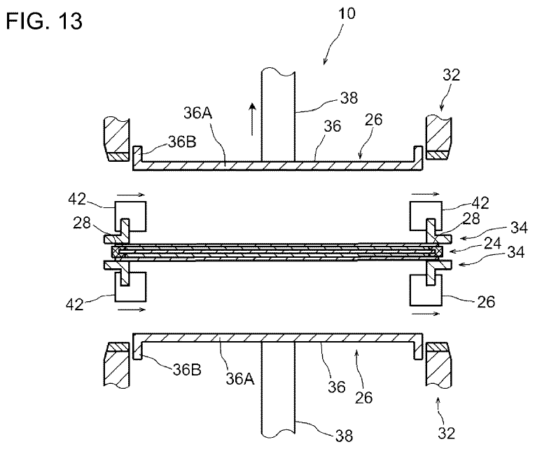

The conveying device 42 is configured to hold the radiator 34 by sandwiching the parallel parts of the U-shaped inner wall part 34B of the radiator 34 from both sides. Herein, the conveying device 42 that holds the lower radiator 34 may be loosely fitted to the inner wall part 34B and support the contact part 34A from below to hold the radiator 34. The conveying device 42 can convey the lithium-ion battery 24 and the pair of radiators 34, while the radiator 34 is in contact with the four sides of the outer edge 28 of the lithium-ion battery 24 (refer to FIG. 13). In addition, the conveying device 42 that holds the lower radiator 34 may hold and convey the lithium-ion battery 24 and the upper radiator 34 together with the lower radiator 34. Alternatively, the lithium-ion battery 24 and the pair of radiators 34 may be conveyed by sandwiching the contact parts 34A of the pair of radiators 34 from lower side and upper side.

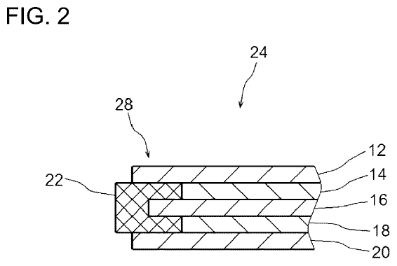

As shown in FIG. 2, the frame member 22 of the lithium-ion battery 24 holds the separator 16 by sandwiching the outer edge of the separator 16 from both sides along the stacking direction and surrounds outer peripheries of the cathode active material layer 14 and the anode active material layer 18. The separator 16 separates the cathode active material layer 14 and the anode active material layer 18. The lithium-ion battery 24 is formed as a rectangular plate that has the cathode current collector 12 whose outer edge is fixed to one side of the frame member 22 so as to cover the cathode active material layer 14, and the anode current collector 20 whose outer edge is fixed to other side of the frame member 22 so as to cover the anode active material layer 18. It is noted that the cathode current collector 12 and the anode current collector 20 are slightly smaller than the frame member 22. Therefore, part of the outer edge of the frame member 22 is exposed from the cathode current collector 12 and the anode current collector 20.

The cathode active material layer 14 is a mixture of cathode active material particles and an electrolytic solution. Herein, the cathode active material layer 14 is in a semi-solid state named such as slurry, funicular, or pendula. The cathode active material particle is LiCoO₂, LiNiO₂, LiMnO₂, LiMn₂O₄, LiFePO₄, ternary material, and the like. The surface of the cathode active material particle can be coated with a coating resin. The cathode active material layer 14 can include a conductive auxiliary agent. The conductive auxiliary agent is a metal such as a carbon material like acetylene black and aluminum. Herein, the coating resin coating the cathode active material particle can include a conductive filler as the same as the material of the conductive auxiliary agent. The cathode active material layer 14 can include a binder. The binder is polyvinylidene fluoride, and so on. The electrolytic solution contains an electrolyte and a nonaqueous solvent. The electrolyte is LiPF₆, LiBF₄, LiSbF₆, LiAsF₆, LiClO₄, LiN(CF₃SO₂)₂, LiN(C₂F₅SO₂)₂, LiC(CF₃SO₂)₃ and the like. The nonaqueous solvent is a lactone compound, cyclic or chained carbonic acid ester, chained carboxylic acid ester, cyclic or chained ether, phosphoric acid ester, nitrile compounds, amide compounds, sulfones, sulfolane, etc or mixtures thereof. The cathode active material layer 14 is housed in a space surrounded by the cathode current collector 12, the separator 16 and the frame member 22.

The anode active material layer 18 is a mixture of cathode active material particles and an electrolytic solution. Herein, the anode active material layer is also in a semi-solid state named such as slurry, funicular, or pendula. The anode active material particles are non-graphitizable carbon (hard carbon), carbon-based active materials such as graphite, metals, alloys, or oxides. The surfaces of the anode active material particles may also be coated with a coating resin. The anode active material layer 18 may also contain a conductive auxiliary agent similar to the conductive auxiliary agent, which is contained in the cathode active material layer 14. The coating resin that coats the anode active material particles may also contain a conductive filler made of the same material as the conductive auxiliary agent. Also, the anode active material portion may contain a binder. The binder is, for example, a waterborne polymer such as a styrene-butadiene copolymer. The electrolytic solution contained in the anode active material layer 18 is the same as the electrolytic solution contained in the cathode active material layer 14. The anode active material layer 18 is housed in a space surrounded by the anode current collector 20, the separator 16 and the frame member 22.

The separator 16 is a microporous membrane of polyolefin such as polyethylene or polypropylene. The thickness of the separator 16 is, for example, 10-25 μm. The material of the frame member 22 is, for example, acrylic resin, urethane resin, epoxy resin, polyethylene resin, polypropylene resin, polyimide resin, rubber (ethylene-propylene-diene rubber: EPDM), isocyanate adhesive, acrylic resin adhesive, cyanoacrylate adhesive, hot melt adhesive (urethane resins, polyamide resins, polyolefin resins), resins obtained by copolymerizing ethylene, propylene, and butene, the main component of which is amorphous polypropylene resin, and the like. The material of the frame member 22 is preferable to be an ethylene-vinyl acetate copolymer or maleic anhydride-modified polyethylene.

The cathode current collector 12 is such a resin collector of a conductive resin or a resin collector, which is a mixture of a non-conductive polymeric material and a conductive filler. The conductive resin is such as polyaniline, polypyrrole, polythiophene, polyacetylene, polyparaphenylene, polyphenylenevinylene, polyoxadiazole, and the like. The non-conductive polymeric material is such as polyethylene (PE; high density polyethylene (HDPE), low density polyethylene (LDPE), etc.), polypropylene (PP), polyethylene terephthalate (PET), polyethernitrile (PEN), polyimide (PI), polyamideimide (PAI), polyamide (PA), polytetrafluoroethylene (PTFE), styrene-butadiene rubber (SBR), polyacrylonitrile (PAN), polymethyl acrylate (PMA), polymethyl methacrylate (PMMA), polyvinyl chloride (PVC), polyvinylidene fluoride (PVdF), polystyrene (PS), and the like. The conductive filler is a metal and/or a conductive carbon. The metal is, for example, at least one metal selected from the group consisting of nickel, titanium, aluminum, copper, platinum, iron, chromium, tin, zinc, indium, antimony, and potassium, or an alloy or metal oxide containing these metals. The conductive carbon is, for example, at least one selected from the group consisting of Acetylene Black, Vulcan (registered trade name), Black Pearl (registered trade name), Carbon Nanofiber, Ketjen Black (registered trade name), Carbon Nanotube (CNT), Carbon Nanohorn, Carbon Nanoballoon, and Fullerene. The anode current collector 20 is a resin current collector similar to the cathode current collector 12.

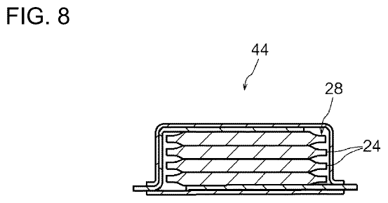

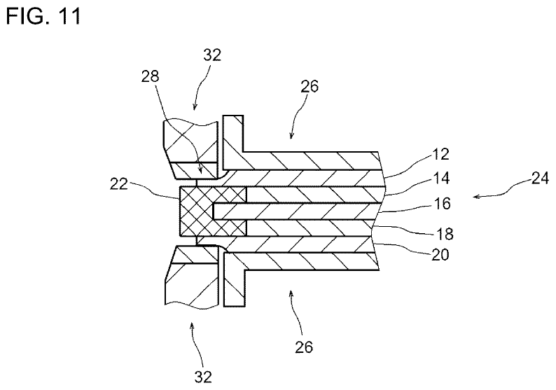

The lithium-ion battery 24 is a single cell, wherein one side is the cathode current collector 12 and the other side is the anode current collector 20. As shown in FIG. 8, the lithium-ion battery module 44 comprises a plurality of stacked lithium-ion batteries 24. The cathode current collector 12 and the anode current collector 20 of the adjacent lithium-ion battery 24 are connected electrically in series. Herein, the outer edge 28 of the lithium-ion battery 24 is sandwiched and pressurized by the pair of the heaters 30 of the sealing devices 32, so that the outer edge 28 becomes thinner than the inner part (refer to FIG. 11).

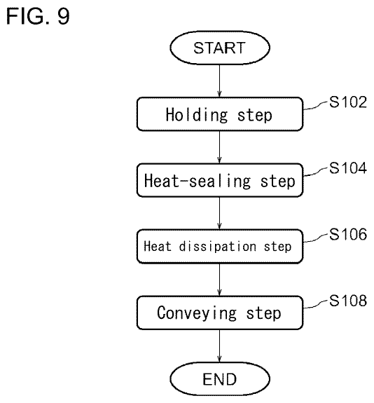

Next, a lithium-ion battery manufacturing method using the lithium-ion battery manufacturing device 10 will be explained according to a flowchart shown in FIG. 9. First, the lithium-ion battery 24 is set in the lithium-ion battery manufacturing device 10, as shown in FIG. 1, a pair of holders 26 sandwich and hold the lithium-ion battery 24 from both sides along the stacking direction (S102: holding step). The holding part 36 of the holder 26 is in contact on the entire inner surface of the outer edge 28 of the lithium-ion battery 24 so as to hold the lithium-ion battery 24. Herein, the lithium-ion battery 24 may be set in the lithium-ion battery manufacturing device 10 by a conveying device, which is not shown in the figure, or through manually.

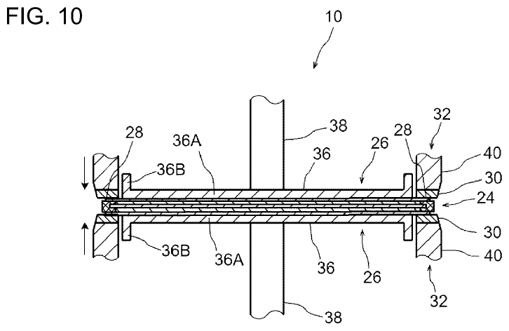

Next, as shown in FIG. 10, the frame-shaped heater 30 of the sealing device 32 touches four sides of the outer edge 28 of the lithium-ion battery 24 so as to heat-seal said four sides at one time (S104: heat-sealing step). More specifically, when the pair of sealing devices 32 approach each other along the vertical direction, the frame-shaped heater 30 presses the outer edge 28 of the lithium-ion battery 24 so as to heat the outer edge 28. Due to this, the outer edge of the cathode current collector 12 and the outer edge of the anode current collector 20 are fixed to the frame member 22, and the outer edge 28 of the lithium-ion battery 24 has been sealed. As shown in FIG. 11, the outer edge 28 of the lithium-ion battery 24 is sandwiched and pressurized by the pair of the heaters 30 of the sealing devices 32 so that the outer edge 28 becomes thinner than the inner portion. Since the frame-shaped heater 30 of the sealing device 32 simultaneously heat-seals the four sides of the outer edge 28 of the lithium-ion battery 24, the four sides of the lithium-ion battery 24 are uniformly heat-sealed. This can prevent the corners only from being heat-sealed more times than the rest of the outer edge 28. Therefore, this can suppress variation in thickness and shape distortion of the outer edge 28. Furthermore, the holder 26 sandwiches and holds the lithium-ion battery 24 from both sides along the thickness direction. Therefore, it is also possible to suppress variations in thickness and shape deformation of the inner part of the outer edge 28 of the lithium-ion battery 24 in the heat-sealing step S104. Also, since the holder 26 holds the lithium-ion battery 24 while being in contact with the entire inner surface of the outer edge 28 of the lithium-ion battery 24, it is possible to suppress the distortion of the lithium-ion battery 24. Herein, the heat-sealing step S104 is preferably performed in a substantial vacuum atmosphere.

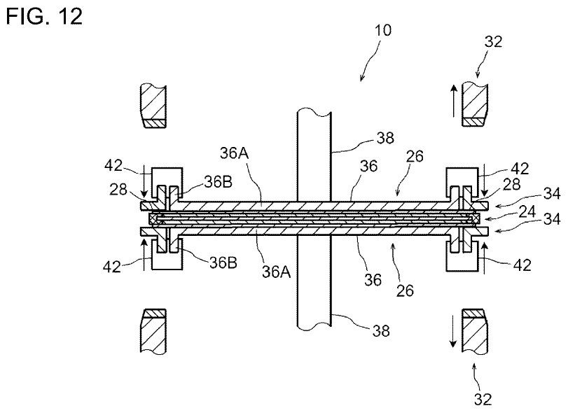

Next, as shown in FIG. 12, the pair of the sealing devices 32 are vertically separated from the lithium-ion battery 24. Instead of the sealing device 32, the radiator 34 abuts on the four sides of the outer edge 28 of the lithium-ion battery 24 to promote heat dissipation from the four sides simultaneously (S106: heat dissipation step). Specifically, firstly, the two U-shaped members constituting each radiator 34 are held by the conveying device 42 at a position spaced apart from the lithium-ion battery 24 along the vertical direction. Then the two U-shaped members approach each other along the horizontal direction to form a rectangular frame-shaped radiator 34. Next, the pair of radiators 34, which are held by the conveying device 42, approach each other along the vertical direction, and abut on both surfaces of the outer edge 28 of the lithium-ion battery 24. Since the radiator is divided into the two U-shaped members, with the holders 26 sandwiching the lithium-ion battery 24 from both sides of the stacking direction, it is possible to easily bring the radiator 34 into contact with the lithium-ion battery 24 while avoiding interference with the support part 38 of the holder 26. Since the radiator 34 promotes the heat dissipation of the four sides of the outer edge 28 of the lithium-ion battery 24 at the same time, the heat dissipation of the outer edge 28 is performed uniformly. Therefore, variations in thickness and shape distortion of the lithium-ion battery 24 due to heat dissipation are also suppressed.

Next, as shown in FIG. 13, the holders 26 are separated from the lithium-ion battery 24 along the vertical direction, the conveying device 42 conveys the lithium-ion battery 24 and the radiator 34 (S108: conveying step), while the radiator 34 is in contact with the four sides of the outer edge 28 of the lithium-ion battery 24. Since the lithium-ion battery 24 and the radiator 34 are conveyed with the radiator 34 being in contact with the four sides of the outer edge 28 of the lithium-ion battery 24, the four outer edges 28 of the lithium-ion battery 24 are evenly dissipated after the conveying. Furthermore, the shape distortion of the lithium-ion battery 24 is mechanically suppressed by the radiator 34. Therefore, variations in the thickness and shape distortion of the lithium-ion battery 24 are suppressed even after the lithium-ion battery 24 is carried out. Thereafter, the heat-sealing of the lithium-ion battery 24 and the like are repeated in the same manner.

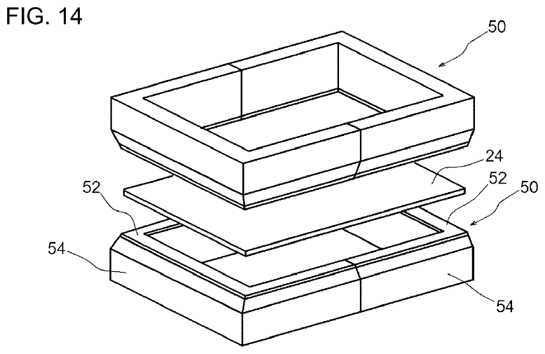

Next, a second embodiment according to this invention will be explained. As shown in FIG. 14, the sealing device 50 according to the second embodiment comprises a frame-shaped heater 52 divided into two U-shaped parts, and a frame-shaped base member 54 divided into two U-shaped parts. The heater 52 is configured by dividing the square frame-shaped heater 30 according to the first embodiment in two parts. Similarly, the base member 54 is configured by dividing the square frame-shaped base member 40 according to the first embodiment in two parts. Since other configurations are the same as those of the first embodiment, the same components are denoted by the same numerical references as in FIGS. 1 to 13, and description thereof is omitted. As shown in this figure, even when the two U-shaped parts are combined to form a rectangular frame-shaped heater 52, the four sides can be heat-sealed simultaneously while the heater 52 being in contact with the four sides of the outer edge 28 of the lithium-ion battery 24. Also in this case, the outer edge 28 of the lithium-ion battery 24 is uniformly pressurized.

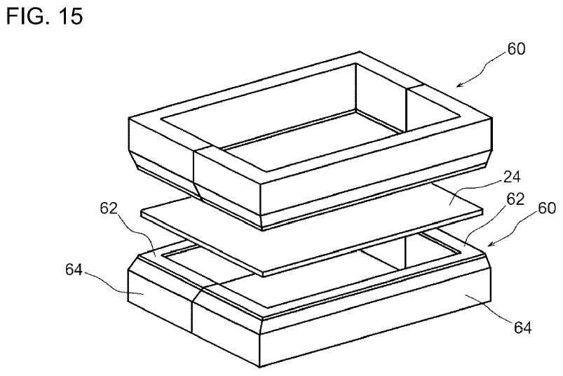

Next, a third embodiment of this invention will be explained. In this third embodiment, in addition to the sealing device 50 of the second embodiment, a sealing device 60 shown in FIG. 15 is equipped. The sealing device 60 also comprises a frame-shaped heater 62 divided into two U-shaped parts, and a frame-shaped base member 64 divided into two U-shaped parts. The heater 62 has a configuration in which the square frame-shaped heater 30 of the first embodiment is divided in two, in a different direction by 90 degrees from the heater 52 of the second embodiment. Similarly, the base member 64 has a configuration in which the square frame-shaped base member 40 of the first embodiment is divided in two, in a different direction by 90 degrees from the base member 54 of the second embodiment. In the third embodiment, the heat-sealing by the sealing device 50 and the heat-sealing by the sealing device 60 are performed. In a word, the heat sealings are performed twice. Since other configurations are the same as those of the first and the second embodiment, the same components are denoted by the same numerical references as in FIGS. 1 to 14, and description thereof is omitted. In a case when the heat-sealing with a heater that is divided into two U-shaped parts, there may be a difference in conditions such as temperature between the vicinity of the contact part of the two U-shaped parts and other parts. Even in such a case, it is possible to alleviate the influence of the difference in conditions such as temperature by conducting both the heat-sealing by the sealing device 50 and the heat-sealing by the sealing device 60. Therefore, variations in the thickness and shape distortion of the lithium-ion battery 24 can be suppressed. Herein, if the lithium-ion battery 24 is square, the sealing device 50 is also square. In this case, one sealing device 50 may perform the heat-sealing twice. More specifically, the square sealing device 50 may be used for the first heat-sealing, and then the square lithium-ion battery 24 may be turned 90 degrees and the same sealing device 50 may be used for the second heat-sealing. Alternatively, the square sealing device 50 may be used for the first heat-sealing, and then the orientation of the same sealing device 50 may be changed by 90 degrees to perform the second heat-sealing.

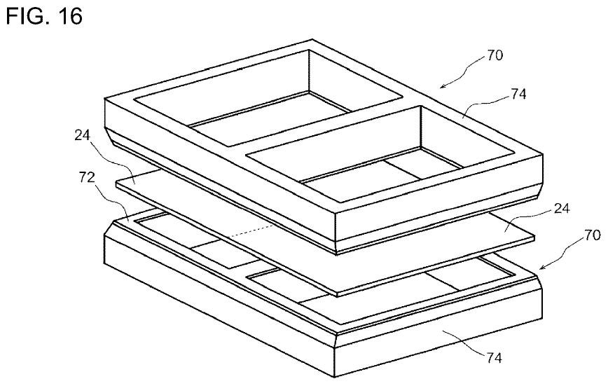

Next, a fourth embodiment of this invention will be explained. As shown in FIG. 16, the sealing device 70 of the fourth embodiment comprises a heater 72 wherein the two square frame-shaped heaters 30 of the first embodiment are integrated into the heater 72, and a base member 74 wherein the two frame-shaped base member 40 of the first embodiment are integrated into the base member 74. Also, an intermediate product, wherein the two lithium-ion batteries 24 of the first embodiment are integrated into the intermediate product, is prepared. The frame member 22 is integrated at the connecting part of the two lithium-ion batteries 24. In the fourth embodiment, two lithium-ion batteries 24 are heat-sealed in one heat-sealing step. After being heat-sealed, the two lithium-ion batteries 24 are separated by a cutter. Herein, two pairs of holders 26 are equipped according to the two lithium-ion batteries 24. Furthermore, in the fourth embodiment, each radiator is divided into two E-shaped members (not shown in the figure). Since other configurations are the same as those of the first embodiment, the same components are denoted by the same numerical references as in FIGS. 1 to 13, and description thereof is omitted. Thus, the heater 72 is combined with two square frame-shaped heaters 30 of the first embodiment. The heater 72 is in contact with four sides of the outer edge 28 of the lithium-ion battery 24 and can heat-seal simultaneously said four sides. Also in this case, the outer edge 28 of the lithium-ion battery 24 is uniformly pressurized. In addition, two lithium-ion batteries 24 can be heat-sealed in one heat-sealing process, which contributes to improving production efficiency. Herein, the sealing device may comprise a square frame-shaped heater consisting of three or more square frame-shaped heaters of the first embodiment, and a base member consisting of three or more frame-shaped base member 40 of the first embodiment. Further, the connecting direction may be one direction (X direction) or two directions (X-Y direction).

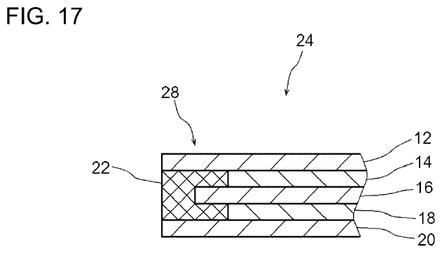

Herein, in the first to fourth embodiments, as shown in FIG. 2, the cathode current collector 12 and the anode current collector 20 are slightly smaller than the frame member 22, and a part of the outer edge of the frame member 22 is exposed from the cathode current collector 12 and the anode current collector 20. Alternatively, the cathode current collector 12 and the anode current collector 20 may have the same size as the frame member 22 as another example shown in FIG. 17. In this case, the outer edge of the frame member 22 is completely coated with the cathode current collector 12 and the anode current collector 20.

Further, in the conveying step S108 in the first to fourth embodiments, the conveying device 42 conveys the lithium-ion battery 24 and the radiator 34 while the radiator 34 is in contact with the four sides of the outer edge 28 of the lithium-ion battery 24. However, in a case when the distortion of the lithium-ion battery 24 after being conveyed does not cause any problems, the lithium-ion battery 24 may be carried out while the radiator 34 is separating from the lithium-ion battery 24.

Furthermore, in the first to third embodiments, the radiator 34 is divided into two U-shaped members. However, the frame-shaped radiator 34 may be divided into two L-shaped members. Also, the frame-shaped radiator 34 may be divided into one U-shaped member and one bar-shaped member.

Further, in the first to fourth embodiments, in the heat dissipation step S106, the radiator 34 is in contact with the four sides of the outer edge 28 of the lithium-ion battery 24 to promote heat dissipation form the four sides at the same time. However, in a case when the distortion of the lithium-ion battery 24 in the heat dissipation step S106 does not cause any problems, a radiator that sequentially dissipates heat from the four sides may be used. In addition, in a case when heat dissipation from the outer edge 28 of the lithium-ion battery 24 is sufficiently performed without using a radiator, the lithium-ion battery manufacturing device 10 is not required to have a radiator.

Moreover, in the second and third embodiments, the heater is divided into two U-shaped portions. However, the frame-shaped heater may be divided into two L-shaped parts. Also, the frame-shaped heater may be divided into one U-shaped part and one bar-shaped part. Also, the frame-shaped heater may be divided into four L-shaped parts. Further, the frame-shaped heater may be divided into four L-shaped portions corresponding to the corners and four bar-shaped portions corresponding to the sides. In these cases, as mentioned in the third embodiment, two types of sealing devices having different contact parts of the plurality of portions constituting the heater may be provided and may perform the heat-sealing twice.

In addition, in the first to fourth embodiments, the holder 26 is composed of holding the lithium-ion battery 24 while being in contact with the entire inner surface of the outer edge 28 of the lithium-ion battery 24. However, as long as the distortion of the lithium-ion battery 24 is sufficiently suppressed, the holder 26 may be configured to hold the lithium-ion battery 24 while being in contact with a part of the inner side of the outer edge 28 of the lithium-ion battery 24. For example, the contact part of the holder may be a frame-shaped part along the inside of the outer edge 28 of the lithium-ion battery 24.

In the first to fourth embodiments, the pair of holders 26 are configured to move up and down. However, only the upper holder 26 may move up and down while the lower holder 26 may be fixed. In this case, in the conveying step S108, the conveying device 42 can convey the pair of radiators 34 and the lithium-ion battery 24 after the conveying device 42 lifts the lower radiator 34 higher than the lower holder 26.

Further, in the first to fourth embodiments, the holding step S102 starts before the heat-sealing step S104. However, the holding step S102 may start simultaneously with the begining of the heat-sealing step S104. Furthermore, the holding step S102 may start after the heat-sealing step S104 starts.

### Example 1

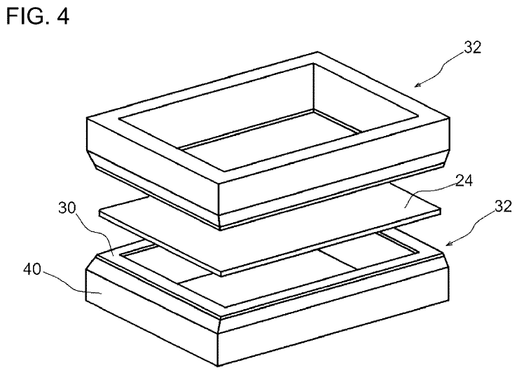

The outer edge of the lithium-ion battery was heat-sealed by a sealing device having a frame-shaped heater, shown in FIG. 4. The conditions of the heat-sealing step are as follows.
Heater shape: square frame shape (integrated)
Sealing temperature: 120° C.
Number of seals: 1 time

Also, the configuration of the lithium-ion battery is as follows. Herein, the thickness is measured before heat-sealing. The frame member is composed of two frames. Specifically, the cathode side frame member and the anode side frame member are sandwiching the separator.
Single cell size: 900 mm×900 mm×900 μm
Frame material size: 900 mm×900 mm×400 μm×2 sheets
Frame hole size: 880 mm×880 mm
Size of cathode current collector and anode current collector: 900 mm×900 mm×50 μm
Separator size: 885 mm×885 mm×25 μm×1 piece

Frame Member Material: Ethylene-Vinyl Acetate Copolymer
Melting point of the frame member: 77, 80° C.
Materials for cathod and anode current collectors: polypropylene (product name “SunAllomer (registered trade name) PL500A” manufactured by SunAllomer Co., Ltd.) (B-1) 75% by mass, acetylene black (AB) (Denka Black (registered trade name)) 20% by mass, modified polyolefin resin (Umex (registered trade name) 1001 manufactured by Sanyo Chemical Industries, Ltd.) 5% by mass

Separator Material: Polypropylene Microporous Film
Cathode active material: nickel/aluminum/lithium cobaltate (core-shell (resin) structure) 100% by mass, acetylene black 0.1% by mass
Anode active material: non-graphitizable carbon (hard carbon) (core-shell (resin) structure) 100% by mass, acetylene black 1.6% by mass
Electrolyte solution: mixed solvent of ethylene carbonate (EC) and propylene carbonate (PC) (volume ratio 1:1), Li[(FSO₂)₂N] (LiFSI) 2 mol/L

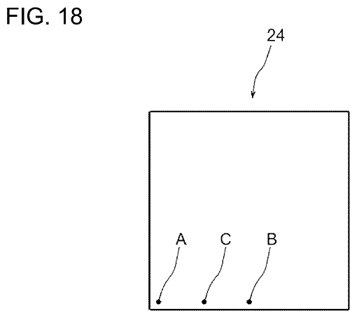

After heat-sealing, as shown in FIG. 18, the thickness of the corner A, the center B of the side, and the middle part C between A and B of the lithium-ion battery 24 were measured using a desktop thickness gauge (manufactured by Mitutoyo). Furthermore, the average thickness of the portion A, the average thickness of the portion B, and the average thickness of the portion C of five lithium-ion batteries, which were heat-sealed under the same conditions, were calculated one by one. Furthermore, the standard deviation of these thicknesses was calculated using the STDEV function. Also, a value was calculated by dividing the standard deviation by the average value of the thickness of the three portions (portions A, B, and C). The average thickness of the portion A, the average thickness of the portion B, the average thickness of the portion C, the standard deviation, and the value obtained by dividing the standard deviation by the average thickness are shown in Table 1.

Furthermore, the resistance value of a lithium-ion battery module was measured, wherein ten lithium-ion batteries that were heat-sealed under the same conditions were stacked in the module. Specifically, after the lithium-ion battery module was completely discharged, the battery was charged, the voltage was checked, and the SOC was adjusted to 50%. After that, it was discharged at 0.1 C for 10 seconds. Based on the current value I_{0.1C} corresponding to 0.1 C and the voltage change ΔV_{0.1C} between the voltage after charging and the voltage after discharging, the DC resistance value (Ω) was calculated by Ohm's law. Furthermore, the area resistance value was calculated by multiplying the electrode area (the area of the cathode active material). The measurement results of the area resistance value are also shown in Table 1.

TABLE 1

| | | | | Thickness of | | | | | Standard | |
|---|---|---|---|---|---|---|---|---|---|---|
| | Heat-Seal Condition | | | Frame | Thickness after sealing | | | Standard | Deviation/ | Area Resistance |
| | | Temperature | Number of | Member | A | B | C | Deviation | Average | Value (10 Stacks) |
| | Heater Shape | [° C.] | Seals | [μm] | [μm] | [μm] | [μm] | [μm] | Value | [Ω · cm²] |
| Example 1 | □ (Frame- | 120 | 1 | 400 | 877 | 922 | 892 | 23 | 2.6% | 150 |
| | Shaped) | | | | | | | | | |
| Example 2 | □ (Frame- | 110 | 1 | 250 | 577 | 621 | 589 | 23 | 3.8% | 142 |
| | Shaped) | | | | | | | | | |
| Example 3 | ⊐ + ⊐ | 120 | 1 | 400 | 883 | 930 | 877 | 29 | 3.2% | 155 |
| Example 4 | ⊐ + ⊐ | 110 | 2 | 400 | 861 | 900 | 881 | 20 | 2.2% | 162 |
| Example 5 | [symbol] | 120 | 1 | 400 | 860 | 871 | 889 | 15 | 1.7% | 152 |
| Comparison 1 | I | 120 | 4 | 400 | 818 | 949 | 850 | 68 | 7.8% | 180 |
| Comparison 2 | I | 110 | 4 | 250 | 462 | 633 | 592 | 89 | 15.9% | 192 |
| Comparison 3 | L | 110 | 2 | 250 | 496 | 599 | 562 | 52 | 9.4% | 210 |
| Comparison 4 | I + ⊐ | 120 | 2 | 400 | 477 | 588 | 555 | 57 | 10.6% | 200 |
| Comparison 5 | □ (Entire | 120 | 1 | 400 | 880 | 900 | 895 | 10 | 1.2% | 384 |
| | Surface) | | | | | | | | | |

### Example 2

The heat-sealing was performed under the following conditions where the sealing temperature and the thickness of the frame member of the lithium-ion battery were different from Example 1 as described below. Other conditions are the same as in Example 1.
Single cell thickness: 600 μm
Sealing temperature: 110° C.
Thickness of frame material: 250 μm×2 sheets

### Example 3

The outer edges of the lithium-ion battery were heat-sealed by the sealing device having a heater whose shape is different from Example 1, as described below. More specifically, the outer edge of the lithium-ion battery was heat-sealed with the sealing device shown in FIG. 14. Herein, the number of seals is one time similar to the first embodiment. Other conditions are the same as in Example 1.
Heater shape: square frame shape (divided into two U-shaped parts)

### Example 4

The heat-sealing was performed under conditions where a sealing temperature and sealing times were different from Example 3, as described below. More specifically, as shown in the third embodiment, the first heat-sealing was performed with a square sealing device, then the orientation of the square lithium-ion battery was changed by 90 degrees, and then the second heat-sealing was performed with the same sealing device. Other conditions are the same as in Example 1 and Example 3.
Sealing temperature: 110° C.
Number of seals: 2 times

### Example 5

The outer edges of the lithium-ion battery were heat-sealed by the sealing device having a heater whose shape is different from Example 1, as described below. More specifically, the outer edge of the lithium-ion battery was heat-sealed with the sealing device shown in FIG. 16. The intermediate product consisting of two integrated lithium-ion batteries of Example 1 was heat-sealed. After being heat-sealed, the two lithium-ion batteries were separated with a cutter. Other conditions are the same as in Example 1.
Heater shape: A configuration in which two square frame-shaped heaters of Example 1 are integrated

[Comparison 1]

The outer edges of the lithium-ion battery were heat-sealed by the sealing device having a heater whose shape is different from Example 1, as described below. More specifically, the outer edge of the lithium-ion battery was heat-sealed four times, one side at a time, by a sealing device having a bar-shaped heater corresponding to one side of the lithium-ion battery. Other conditions are the same as in Example 1.
Heater shape: bar-shaped
Number of seals: 4 times

[Comparison 2]

The outer edges of the lithium-ion batteries were heat-sealed by a sealing device under conditions where a sealing temperature and a thicknesses of a frame member of a lithium-ion battery are different from Comparison 1, as described below. More specifically, the outer edge of the lithium-ion battery was heat-sealed four times, one side at a time, by a sealing device having a bar-shaped heater corresponding to one side of the lithium-ion battery. Other conditions are the same as in Comparison 1.
Thickness of a single cell: 600 μm
Sealing temperature: 110° C.
Thickness of frame member: 250 μm×2 sheets

[Comparison 3]

The heat-sealing was performed under conditions where a heater shape and sealing times are different from Comparison 2, as described below. More specifically, the two outer edges of the lithium-ion battery were heat-sealed twice by a sealing device having L-shaped heaters corresponding to two sides of the lithium-ion battery. Other conditions are the same as in Comparison 2.
Heater shape: L-shaped
Number of seals: 2 times

[Comparison 4]

The heat-sealing was performed under conditions where a heater shape and sealing times are different from Comparison 1, as described below. More specifically, the outer edge of the lithium-ion battery was heat-sealed twice (one side and three sides) by a sealing device having a bar-shaped heater corresponding to one side of the lithium-ion battery and a sealing device having a U-shaped heater corresponding to three sides of the lithium-ion battery. Other conditions are the same as in Comparison 1.
Heater shape: bar-shaped and U-shaped
Number of seals: 2 times

[Comparison 5]

The entire surface of the lithium-ion battery was heat-sealed by a sealing device having a different heater shape from Comparison 1, as described below. More specifically, the entire surface of the lithium-ion battery was heat-sealed by a sealing device having a square plate-shaped heater corresponding to the entire surface of the lithium-ion battery. Other conditions are the same as in Comparison 1.
Heater shape: Square plate-shaped (entire surface)

As for Examples 2 to 5 and Comparisons 1 to 5, the thicknesses of the three portions A, B, and C of the lithium-ion battery 24 were measured the same as in Embodiment 1. Furthermore, the average value of the thickness of portion A, the average value of the thickness of portion B, and the average value of the thickness of portion C among the five lithium-ion batteries were calculated. Herein, the thickness of portion A in Comparisons 1-4 is the thickness of the corner heat-sealed twice. Further, the standard deviation of these thicknesses was calculated using the STDEV function. Furthermore, the value was calculated by dividing the standard deviation by the average value of the thickness of the three portions (portions A, B, and C). The average value of the thickness of portion A, the average value of the thickness of portion B, the average thickness of portion C, the standard deviation, and the standard deviation/the average value of the thickness among Examples 2 to 5 and Comparisons 1 to 5 are also shown in Table 1.

As shown in Table 1, the standard deviation of the thickness of the heat-sealed lithium-ion battery and the standard deviation/the average value of the thickness of portions A, B, and C among Examples 1-5 were remarkably smaller than those among Comparisons 1-4. In a word, the variation in thickness of the lithium-ion batteries among Examples 1-5 was significantly smaller than the variation in thickness of the lithium-ion batteries among Comparisons 1-4. In addition, the area resistance value of the lithium-ion battery module, in which ten lithium-ion batteries were stacked, among Examples 1-5 was lower than that among Comparisons 1-4. Both the standard deviation of the thickness of the heat-sealed lithium-ion battery and the standard deviation/the average thickness in Comparison 5 was smaller than those among Examples 1-5. However, the area resistance value of the lithium-ion battery module, in which ten lithium-ion batteries were stacked, in Comparison 5 was significantly higher than that among Examples 1-5.

### INDUSTRIAL APPLICABILITY

The present invention can be applied to heat-seals for lithium-ion batteries.

### REFERENCE SIGNS LIST

10 lithium-ion battery manufacturing device
12: cathode current collector
14: cathode active material layer
16: separator
18: anode active material layer
20 anode current collector
22: frame member
24: lithium-ion battery
26: holder
28: outer edge
52, 62, 72: heater
32, 50, 60, 70: sealing device
34: radiator
36: holding part
36A: contact part
36B: outer wall part
38: support part
54, 64, 74: base member
42: conveying device
44: lithium-ion battery module
S102: holding step
S104: heat-sealing step
S106: heat dissipation step
S108: conveying step

1. A lithium-ion battery manufacturing device,
wherein the lithium-ion battery comprises a cathode current collector, a cathode active material layer, a separator, an anode active material layer, and an anode current collector that are stacked,
wherein the lithium-ion battery has a circular frame member that fixes an outer edge of the separator, which is placed between the cathode current collector and the anode current collector, and that seals the cathode active material layer, the separator, and the anode active material layer, and
wherein the lithium-ion battery manufacturing device comprising:
a holder that sandwiches the lithium-ion battery from both sides of the stacking direction; and
a sealing device that has a frame-shaped heater, which heat-seals an outer edge of the lithium-ion battery by heating the frame member placed at said outer edge of the lithium-ion battery.

2. The lithium-ion battery manufacturing device according to claim 1,
wherein the frame member holds the separator by sandwiching the outer edge of the separator from both sides along the stacking direction and surrounds outer peripheries of the cathode active material layer and the anode active material layer,
wherein the separator separates the cathode active material layer and the anode active material layer,
wherein the lithium-ion battery is formed as a rectangular plate that has the cathode current collector whose outer edge is fixed to one side of the frame member so as to cover the cathode active material layer, and the anode current collector whose outer edge is fixed to another side of the frame member so as to cover the anode active material layer, and
wherein the heater is pressed on the outer edge of the lithium-ion battery and heats the frame member.

3. The lithium-ion battery manufacturing device according to claim 1,
wherein the holder is configured to hold the lithium-ion battery while being in contact with an entire inner surface of the outer edge of the lithium-ion battery.

4. The lithium-ion battery manufacturing device according to claim 1, further comprising:
a radiator that is in contact with four sides of the outer edge of the lithium-ion battery, and that is operable to simultaneously promote heat dissipation from said four sides.

5. The lithium-ion battery manufacturing device according to claim 4,
wherein the radiator is a rectangular frame-shaped member and is divided into two U-shaped members.

6. The lithium-ion battery manufacturing device according to claim 4, further comprising:
a conveying device that is operable to convey the lithium-ion battery and the radiator, while the radiator is in contact with the four sides of the outer edge of the lithium-ion battery.

7. A lithium-ion battery manufacturing method,
wherein the lithium-ion battery comprises a cathode current collector, a cathode active material layer, a separator, an anode active material layer, and an anode current collector that are stacked,
wherein the lithium-ion battery has a circular frame member that fixes an outer edge of the separator, which is placed between the cathode current collector and the anode current collector, and that seals the cathode active material layer, the separator, and the anode active material layer, and
wherein the lithium-ion battery manufacturing method comprising:
a holding step of sandwiching the lithium-ion battery from both sides of the stacking direction using a holder; and
a heat-sealing step of heat-sealing an outer edge of the lithium-ion battery by heating the frame member placed at said outer edge of the lithium-ion battery using a frame-shaped heater of a sealing device.

8. The lithium-ion battery manufacturing method according to claim 7,
wherein the frame member holds the separator by sandwiching the outer edge of the separator from both sides along the stacking direction and surrounds outer peripheries of the cathode active material layer and the anode active material layer,
wherein the separator separates the cathode active material layer and the anode active material layer,
wherein the lithium-ion battery is formed as a rectangular plate that has the cathode current collector whose outer edge is fixed to one side of the frame member so as to cover the cathode active material layer, and the anode current collector whose outer edge is fixed to another side of the frame member so as to cover the anode active material layer, and
wherein the heater is pressed on the outer edge of the lithium-ion battery and heats the frame member in the heat-sealing step.

9. The lithium-ion battery manufacturing method according to claim 7,
wherein the holder holds the lithium-ion battery while being in contact with an entire inner surface of the outer edge of the lithium-ion battery in the holding step.

10. The lithium-ion battery manufacturing method according to claim 7, further comprising:
a heat dissipation step of simultaneously promoting heat dissipation from four sides of the outer edge of the lithium-ion battery while a radiator is in contact with said four sides.

11. The lithium-ion battery manufacturing method according to claim 10,
wherein the radiator is a rectangular frame-shaped member and is divided into two U-shaped members.

12. The lithium-ion battery manufacturing method according to claim 10, further comprising:
a conveying step of conveying the lithium-ion battery and the radiator using a conveying device, while the radiator is in contact with the four sides of the outer edge of the lithium-ion battery.
